(19) United States
(12) Patent Application Publication
(10) Pub. No.: US 2026/0218490 A1
(43) Pub. Date: Jul. 30, 2026

(54) LIFTING MACHINE

(71) Applicant: MANITOU BF, ANCENIS (FR)

(72) Inventors: Thomas DORE, ANCENIS (FR); Gwenaël PRIOUR, ANCENIS (FR)

(21) Appl. No.: 19/148,545

(22) PCT Filed: Jan. 24, 2024
(86) PCT No.: PCT/EP2024/051659

§ 371 Date: Jul. 16, 2025

(30) Foreign Application Priority Data
Jan. 27, 2023 (FR) FR2300789

(51) Int. Cl. E02F 9/22; B66F 9/22; E02F 3/42; E02F 9/26; F15B 15/28

(52) U.S. Cl. CPC E02F 9/2214; B66F 9/22; E02F 9/265; F15B 15/2815; E02F 3/422

(57) ABSTRACT

The invention relates to a lifting machine (1) comprising: a main body (2), a manipulator arm (3), a hydraulic actuator that is configured to move the manipulator arm,

a hydraulic supply device; and

a control system comprising:
a control unit (7) that is configured to receive a movement request signal and to control the hydraulic supply device in response to the movement request signal,
a position sensor (13, 14, 15) that is configured to transmit a position signal representative of a position of the hydraulic actuator to the control unit, the control unit also being configured to detect an end-of-travel stop position of the hydraulic actuator on the basis of the position signal and to command the hydraulic supply device so as to stop the supply of pressure to the hydraulic actuator in response to the detection of the end-of-travel stop position.

### TECHNICAL FIELD

The invention relates to the field of lifting machines such as loaders or elevators, and more particularly to a control system for a hydraulic actuator installed in such a lifting machine.

### TECHNOLOGICAL BACKGROUND

Lifting machines comprising a mobile arm and a hydraulic actuator configured to move the arm in response to signals transmitted by a control system of the hydraulic actuator are known. In this type of machine, the operator activates a movement command until an end-of-travel stop of the hydraulic actuator is reached. However, if the operator maintains the movement command for the hydraulic actuator while the hydraulic actuator is at the end-of-travel stop, this causes excessive energy consumption, which is thus lost.

Moreover, EP3885586 describes an excavator comprising a system for limiting the drive control of the hydraulic actuator in order to stop it from moving before it reaches an end of travel of the hydraulic cylinder, in order to prevent an impact at the end-of-travel stop of the hydraulic cylinder.

### SUMMARY OF THE INVENTION

The inventors have also found that forcibly maintaining abutment of a hydraulic actuator against a stop at the end of travel causes a number of drawbacks, such as:
a drop in the engine speed, which can cause a lower-power combustion engine to stall;
a limited range, in particular on account of excessive energy consumption when the hydraulic actuator is kept in abutment at its stop;
a loss of hydraulic performance;
an increase in lifting machine noise; and/or
premature aging of the components on account of unnecessary pressure in the hydraulic circuit.

The inventors have also found that prior art machines comprising a system for limiting control as indicated above are unable to carry out all of the desired manipulations, in particular when the action of causing a hydraulic actuator to butt against a stop at the end of travel is useful in order to achieve a result.

Such a situation exists, for example, for the tilt cylinder of a bucket carried by the arm in order to:
help to discharge a load present in the bucket by creating vibratory impacts resulting from successive abutments against stops; and
allow effective digging.

One idea underlying the invention is to solve the abovementioned problems.

One idea underlying the invention is to create a lifting machine that does not have one or more of the abovementioned problems.

According to one embodiment, the invention provides a lifting machine comprising: a main body,
a manipulator arm that is mounted on said main body and is movable with respect to the main body,
a hydraulic actuator that is configured to move the manipulator arm,
a hydraulic supply device that is connected to the hydraulic actuator; and
a control system comprising:
   a control unit that is configured to receive a movement request signal from a human-machine interface and to command the hydraulic supply device in response to the movement request signal so as to cause the manipulator arm to move on the basis of the movement request signal,
   a position sensor that is configured to transmit a position signal representative of a position of the hydraulic actuator to the control unit, the control unit also being configured to detect an end-of-travel stop position of the hydraulic actuator on the basis of the position signal and to command the hydraulic supply device so as to stop the supply of pressure to the hydraulic actuator in response to the detection of the end-of-travel stop position.

By virtue of these features, the machine has the following advantages:
a reduction in energy consumption if the operator maintains the movement command for the hydraulic actuator while the hydraulic actuator is at the end-of-travel stop,
in increase in the service life of the machine,
a reduction in noise and vibrations,
an improvement in the availability of hydraulic pressure when the hydraulic supply device is also connected to another element of the lifting machine.

According to embodiments, such a lifting machine may have one or more of the following features.

According to one embodiment, the control unit commands the stopping of the supply of pressure to the hydraulic actuator after a delay time has elapsed starting from the detection of the end-of-travel stop position, the delay time being less than or equal to 5 seconds.

The delay time creates a controlled delay between the time at which the end-of-travel stop position is detected, this detection being able to have a margin or error, and the interruption to the supply of the hydraulic actuator. Thus, the hydraulic actuator is effectively brought into abutment against the stop before the supply of pressure to the hydraulic actuator is stopped, in spite of a possible margin of error of the detection of the end-of-travel stop position.

According to one embodiment, the delay time is between 0.5 second and 5 seconds.

According to one embodiment, the delay time is in a range chosen from: between 0.5 second and 1 second; between 0.5 second and 2 seconds; between 0.5 second and 3 seconds; between 0.5 second and 4 seconds; between 1 second and 2 seconds; between 1 second and 3 seconds; between 1 second and 4 seconds; between 2 seconds and 3 seconds; between 2 seconds and 4 seconds; between 3 seconds and 4 seconds.

According to embodiments, the position sensor may comprise a linear position sensor or an angular position sensor. Appropriate position sensors are, for example, capacitive sensors, Hall effect magnetic sensors, optical sensors, or the like.

According to one embodiment, the position sensor comprises a Hall effect magnetic sensor positioned so as to measure the field of a magnet carried by a mobile part of the hydraulic actuator.

According to one embodiment, the position signal is a quantitative signal and the control unit is configured to detect the end-of-travel stop position of the hydraulic actuator on the basis of the position signal by comparing a quantity represented by the position signal with a reference value stored in a memory.

According to one embodiment, the position sensor is an end-of-travel sensor that is configured to detect an end-of-travel stop position of the hydraulic actuator and to transmit a position signal representative of the end-of-travel stop position of the hydraulic actuator to the control unit.

Thus, the position signal transmitted by the end-of-travel sensor can be directly representative of the end-of-travel stop position and does not require subsequent processing by the control unit.

In this case, the position signal representative of the end-of-travel stop position may be in the form of a logic signal or Boolean signal. According to one embodiment, the end-of-travel sensor may be an electrical contact which closes or opens in the stop position.

According to one embodiment, the hydraulic actuator is a cylinder comprising a cylindrical part defining an internal chamber and a piston sliding in said internal chamber, and wherein the end-of-travel stop position of the hydraulic actuator corresponds to contact between a first stop piece secured to the cylinder and a second stop piece secured to the piston.

According to one embodiment, the first and second stop pieces are situated inside the internal chamber. According to one embodiment, the first stop piece comprises a rear flange situated at a first end of the internal chamber. According to one embodiment, the second stop piece comprises a front flange situated at a second end of the internal chamber.

According to one embodiment, the first and second stop pieces are situated outside the internal chamber.

According to one embodiment, the piston has a stop portion situated outside the internal chamber, the stop portion being inserted into a groove located between the first and second stop pieces.

According to one embodiment, the lift arm has a first end mounted on said main body and a second end opposite to the first end, wherein the hydraulic actuator is a tilt cylinder that is disposed at the second end of the lift arm and intended to tilt a tool with respect to the lift arm.

According to one embodiment, the tool is chosen from a bucket, a clamp, a fork, a jib crane, a lift or a load backrest.

According to one embodiment, the hydraulic supply device comprises at least one pump driven by a motor, and at least one hydraulic distributor.

According to one embodiment, the hydraulic supply device is a proportional distributor, for example an electro-proportional distributor.

According to one embodiment, the motor is a combustion engine. According to one embodiment, the combustion engine is a low-power combustion engine.

The human-machine interface may take on different forms and have one or more members, for example a voice recognition interface, a touchscreen, handles, pedals, buttons or the like. According to one embodiment, the human-machine interface comprises a manipulator that is intended to be manipulated by an operator in order to produce the movement request signal. According to one embodiment, the manipulator comprises one or more handles.

According to one embodiment, the lifting machine is chosen from:
a telescopic arm lift truck;
a loader;
an aerial personnel lift;
a warehousing machine;
a mast lift truck.

According to one embodiment, the hydraulic actuator is a cylinder chosen from: a tilt cylinder, a telescoping cylinder, and a lift cylinder.

According to one embodiment, the manipulator arm is a telescopic arm.

According to one embodiment, the lifting machine comprises a pair of front wheels and a pair of rear wheels.

According to one embodiment, the lifting machine comprises a plurality of hydraulic actuators that are configured to move the manipulator arm, and the hydraulic supply device is connected to the plurality of hydraulic actuators, the lifting machine comprising at least one position sensor per actuator, each position sensor being respectively configured to transmit a position signal representative of a position of one hydraulic actuator from the plurality of hydraulic actuators to the control unit, the control unit being configured to detect an end-of-travel stop position of each hydraulic actuator.

According to one embodiment, the plurality of hydraulic actuators comprise a digging cylinder, a telescoping cylinder and a lift cylinder.

According to one embodiment, the lifting machine comprises a state selector that is configured to selectively activate and deactivate in a reversible manner the response of the control unit to the detection of the end-of-travel stop position.

According to one embodiment, the state selector has a first state in which the response of the control unit to the detection of the end-of-travel stop position is deactivated, meaning that the control unit does not stop the supply of pressure to the hydraulic actuator in response to the detection of the end-of-travel stop position, and a second state in which the response of the control unit to the detection of the end-of-travel stop position is activated, meaning that the control unit stops the supply of pressure to the hydraulic actuator in response to the detection of the end-of-travel stop position.

According to one embodiment, the state selector is a switch that is intended to be toggled into the first state or the second state by an operator. When the operator places the state selector in the first state, the response of the control unit to the detection of the end-of-travel stop position is deactivated. When the operator places the state selector in the second state, the response of the control unit to the detection of the end-of-travel stop position is activated.

### BRIEF DESCRIPTION OF THE FIGURES

The invention will be understood better, and further aims, details, features and advantages thereof will become more clearly apparent from the following description of several particular embodiments of the invention, which are given purely by way of nonlimiting illustration, with reference to the appended drawings.

FIG. 1 shows a schematic view of a lifting machine according to one embodiment.

FIG. 2 is a functional diagram showing a control system for a hydraulic actuator installed in the lifting machine shown in FIG. 1.

FIG. 3 is a graph showing different parameters implemented in the control system in FIG. 2 during actuation of the hydraulic actuator.

FIG. 4 shows a hydraulic actuator according to a first embodiment in abutment, in a retracted position.

FIG. 5 shows the hydraulic actuator from FIG. 4 in abutment, in an extended position.

FIG. 6 shows a hydraulic actuator according to a second embodiment in abutment, in a retracted position.

FIG. 7 shows the hydraulic actuator from FIG. 6 in abutment, in an extended position.

### DESCRIPTION OF THE EMBODIMENTS

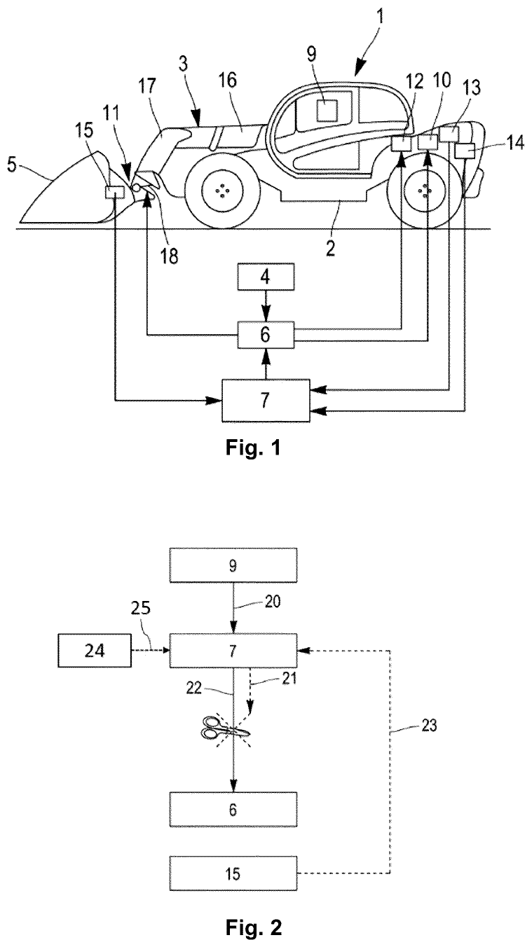

FIG. 1 illustrates a lifting machine 1, for example a telescopic arm lift truck, comprising a main body having a chassis 2, an operator's cab and two pairs of wheels. The lifting machine 1 comprises a manipulator arm 3 that is carried by the chassis 2 and provided with one or more hydraulic actuators and a hydraulic supply device 6 for supplying the hydraulic actuator(s). The hydraulic supply device 6 comprises a hydraulic pump driven by a motor 4, for example a combustion engine or an electric motor.

The manipulator arm 3 is mounted pivotably about a transverse horizontal axis. The manipulator arm 3 can move from a low position to a high position and vice versa with the aid of a first hydraulic actuator 10 such as a lift cylinder. The first hydraulic actuator 10 may comprise a single double-acting cylinder supplied with fluid by the hydraulic pump. A pair of parallel single-acting cylinders that are supplied in turns with fluid could be used in an equivalent manner.

The manipulator arm 3 illustrated in FIG. 1 is telescopic arm with a length that is adjustable in a retraction direction and in an extension direction. The manipulator arm 3 is formed of a first section 16 coupled to the chassis 2 and a second section 17 mounted slidably in the first section 16.

In a variant, it is possible for the manipulator arm 3 not to be telescopic.

The movement of the manipulator arm 3 between the retracted position and the extended position is achieved via a second hydraulic actuator 12 present in the manipulator arm 3, such as a telescoping cylinder.

As indicated in a similar way above, use can be made of a double-acting cylinder or of two parallel single-acting cylinders that are supplied in turns.

The manipulator arm 3 is equipped with a tool holder 11 mounted pivotably at the distal end of the second section 17 of the manipulator arm 3. The tool holder 11 illustrated in FIG. 1 carries a bucket 5. In a variant, the tool holder 11 is a universal tool holder, designed to receive a plurality of tools. The operator can thus choose the desired tool and secure it to the tool holder 11.

The tool holder 11 is connected to the manipulator arm 3 via a third actuator 18. This third actuator 18 makes it possible to drive the tool holder 11 in movement in a digging direction and in a discharging direction by pivoting the tool holder 11 about a transverse horizontal axis. The discharging position corresponds to the extreme position, pivoted toward the ground of the tool holder 11 and of the associated tool. The digging position of the tool holder 11 corresponds to an upwardly pivoted position of the tool holder 11 and of the associated tool.

The lifting machine 1 also comprises a control unit 7 configured to command the operation of the first, second and third hydraulic actuators 10, 12, 18, thereby making it possible to control the movements of the manipulator arm 3 and of the tool holder 11. For example, the control unit 7 receives a movement request signal from the manipulator 9 of the handle type that is manipulated by an operator. These movement request signals can be interpreted by the control unit 7 as signals for instructing the movement of the manipulator arm 3 and/or of the tool holder 11.

The control unit 7 is an electronic and/or computer unit which comprises, for example, a microcontroller or a microprocessor associated with a memory.

Thus, when the control unit is stated to be configured to carry out a given operation, this means that the control unit comprises computer instructions and execution hardware that make it possible carry out said operation and/or corresponding electronic components. In other words, the functions and steps described below can be implemented in the form of a computer program and/or via hardware components. In particular, the functions and steps carried out by the control unit 7 can be realized via sets of instructions and computer modules implemented in a processor or controller and/or realized by dedicated electronic components or components of the FPGA or ASIC type. It is also possible to combine computer parts and electronic parts.

The lifting machine 1 comprises position sensors 13, 14, 15. A first position sensor 13 associated with the first hydraulic actuator 10 in order to measure a parameter representative of the position of the first hydraulic actuator 10, for example an angular position of the manipulator arm 3. A second position sensor 14 is associated with the second hydraulic actuator 12 in order to measure a parameter representative of the position of the second hydraulic actuator 12, for example a length of the manipulator arm, and a third position sensor 15 is associated with the third hydraulic actuator 18 in order to measure a parameter representative of the position of the third hydraulic actuator 18, for example the angular position of the tool.

The first, second and third position sensors 13, 14, 15 are also configured to transmit position signals that in each case represent the measured parameter to the control unit 7.

These position signals allow the control unit 7 to determine whether the corresponding hydraulic actuator has reached an end-of-travel stop position.

According to one embodiment, the control unit 7 comprises a memory for processing the received position signal. The memory is calibrated in order to store a first position value representative of the abutment of the hydraulic actuator, in the retracted position, and a second value representative of the abutment of the hydraulic actuator in the extended position. Thus, when the control unit 7 receives a position signal, the control unit 7 compares the position signal with the first and the second value stored in the memory, and if the position signal reaches or exceeds the first value or the second value, the control unit 7 detects the corresponding end-of-travel stop position. In response to this detection, it interrupts the control signal and therefore causes the stoppage of the hydraulic supply of the hydraulic actuator, optionally after a delay time starting from the detection of the end-of-travel stop position has elapsed.

In an embodiment variant, the position sensor is an end-of-travel sensor configured both to detect an end-of-travel stop position of the hydraulic actuator and to transmit to the control unit 7 a position signal representative of the end-of-travel stop position of the hydraulic actuator, that is to say an end-of-travel stop signal, in the retracted or extended position. Such an end-of-travel stop position of the hydraulic actuator is triggered, for example, via an electrical contact which closes or opens in the stop position. Thus, subsequent processing of the end-of-travel stop position by the control unit 7 is not necessary since the stop position has already been detected by the end-of-travel sensor.

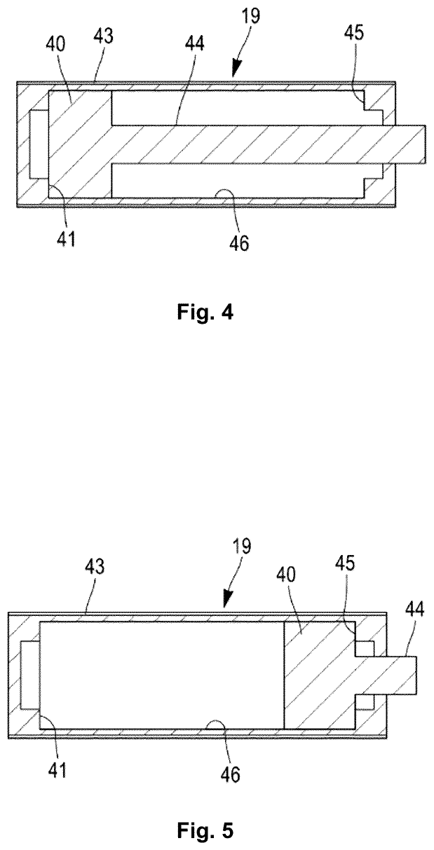

Several types of end-of-travel stops of a hydraulic cylinder 19 are illustrated in FIGS. 4 to 7.

Such a hydraulic cylinder 19 comprises a cylindrical part 43, defining an internal chamber 46, and a piston 40 that is positioned in the internal chamber 46 and is able to slide in a longitudinal direction of the internal chamber 46.

According to one embodiment shown in FIGS. 4 and 5, the end-of-travel positions of the piston 40 are delimited by abutment inside the internal chamber 46. Thus, the piston 40 is capable of sliding from a rear flange 41 situated at a first end of the internal chamber 46 in the direction of a front flange 45 situated at a second end of the internal chamber 46, until said piston 40 of the hydraulic cylinder 10 comes into abutment against the front flange 45.

Conversely, the piston 40 is capable of sliding from the front flange 45 at the second end of the internal chamber 46 in the direction of the first end of the internal chamber 46 until the piston 40 of the cylinder 10 comes into abutment against the rear flange 41.

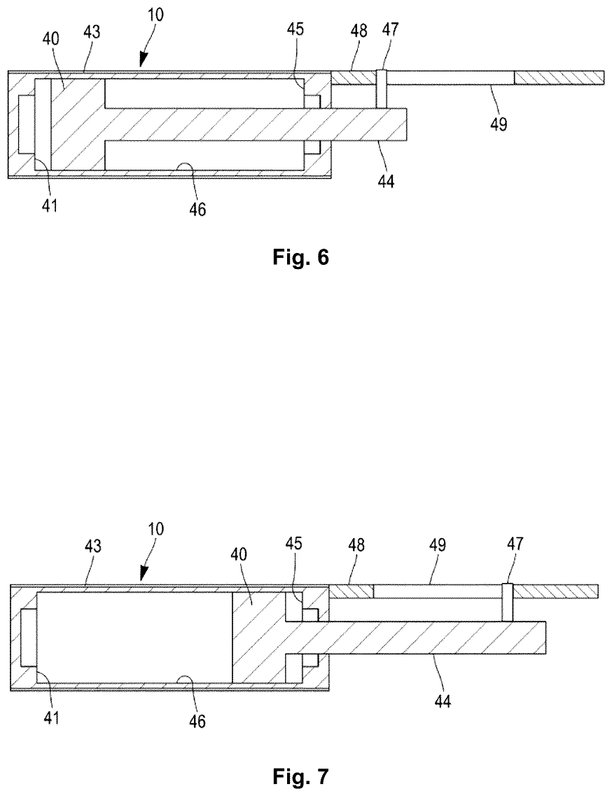

According to another embodiment shown in FIGS. 6 and 7, the end-of-travel positions of the piston 40 are delimited by abutment outside the internal chamber 46. Thus, the hydraulic cylinder 19 also comprises a stop element 47 that protrudes from the rod 44 of the piston 40. The stop element 47 is situated outside the internal chamber 46 and inserted into a sliding groove 49 formed in a first stop piece 48 secured to the cylinder 43. During the actuation of the cylinder 19, the stop element 47 slides in the longitudinal direction of the sliding groove 49 between two stop positions defined by the two ends of the sliding groove 49.

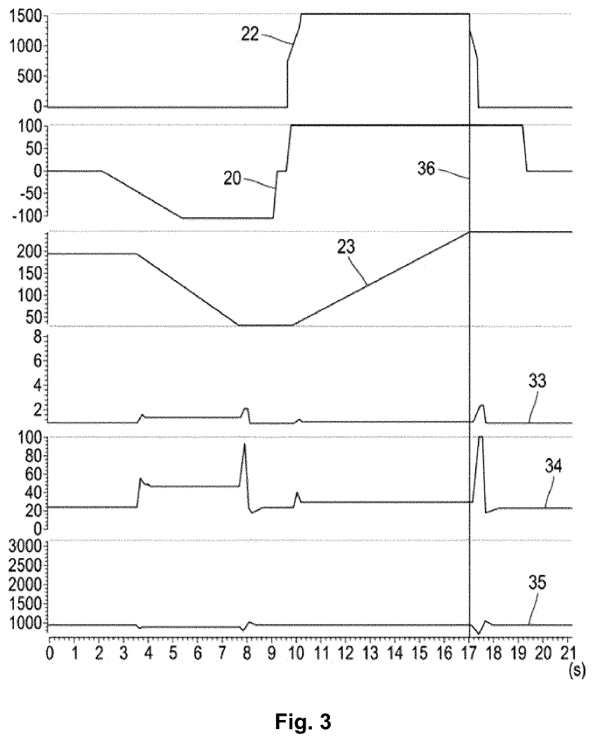

FIGS. 2 and 3 illustrate the operation and the consequences of the control system as shown in FIG. 1 during the actuation of the third hydraulic actuator 18 corresponding to a tilt cylinder.

When the operator wishes to bring about a movement of the bucket 5, the first step consists in actuating the manipulator 9 in order to transmit a movement request signal 20 to the control unit 7.

The second step is the acquisition of the movement request signal 20 and the processing of said signal by the control unit 7.

In a third step, the control unit 7 sends a control signal 22 to the hydraulic supply device in order to set the third hydraulic actuator 18 in movement.

In a fourth step, the position sensor 15 detects a position of the third hydraulic actuator 18 corresponding to an end-of-travel stop as illustrated in FIGS. 4 to 7 and transmits a position signal 23 representative of the end-of-travel stop of the third hydraulic actuator 18 to the control unit 7. The control unit 7 then interrupts the control signal 22, as indicated by the arrow 21, optionally after a predetermined delay time has elapsed, in order to stop the movement of the third hydraulic actuator 18.

Thus, even if the operator maintains the request for thrust movement in the direction of the stop position of the third hydraulic actuator 18, the hydraulic thrust at the end-of-travel stop is stopped.

The third hydraulic actuator 18 is set back in movement when the control direction is reversed, i.e. when the operator actuates the manipulator 9 in order to transmit a movement request signal in the opposite direction to the control unit 7.

The advantages of this control method will now be explained by way of the graphs illustrated in FIG. 3. The x axis is common to all of the graphs and represents the passage of time in seconds(s).

Six graphs are illustrated, showing:
20: the movement request signal 20 produced by the manipulator 9 of the hydraulic actuator, with a percentage of the request transmitted with respect to a maximum request on the y axis. In this example, the operator keeps the manipulator 9 in a position for requesting a movement of the bucket 5 from the time 9 s to the time 19 s.
22: the control signal 22 for setting the hydraulic actuator 18 in movement, produced by the control unit 7 and sent to an electro-proportional distributor, with the strength of the signal in mA on the y axis.
23: the signal for the position of the rod of the hydraulic actuator 18 in millimeters.
33: the consumption of the combustion engine 4 in liters of diesel/hour.
34: the fill factor of the combustion engine 4 in percent.
35: the speed of the combustion engine 4 in rpm.

The reference 36 schematically represents the time at which the hydraulic actuator 18 comes into hydraulic abutment, at around 17 s.

It is visible from the curves 20 and 23 that the operator maintains the movement request for the hydraulic actuator after an end-of-travel stop position of the hydraulic actuator has been reached, shown in the third graph, to the right of the straight line 36, after 17 seconds.

Despite the fact that the movement request 20 is maintained, the control unit 7 stops the control signal 22 for the hydraulic actuator 18 just after the reference 36. After a time delay of 0.5 s has elapsed, the strength of the signal decreases rapidly from 1500 mA to 0 mA. Thus, the hydraulic supply device 6 no longer supplies the hydraulic actuator 18.

Thus, by virtue of these features, the fill factor 34 and the consumption 33 of the combustion engine 4 are each observed to have a brief increase spike which is rapidly reversed after the reference 36 and will before the end of the movement request 20. Moreover, the engine speed 35 drops only briefly.

The same steps can be applied independently for the other hydraulic actuators.

According to an embodiment variant illustrated in FIG. 2, the control system of the lifting machine comprises a state selector 24, for example a switch, which is configured to selectively activate and deactivate in a reversible manner the response of the control unit 7 to the detection of the end-of-travel stop position.

When the operator places the state selector 24 in a first state, the state selector 24 transmits a signal 25 for interrupting the detection of the end-of-travel stop position to the control unit 7 and the response of the control unit 7 to the detection of the end-of-travel stop position is deactivated. Such an action is reversible, meaning that when the operator places the state selector 24 in a second state, the interruption signal 25 is not transmitted and the response of the control unit 7 to the detection of the end-of-travel stop position is activated.

Although the invention has been described in conjunction with several particular embodiments, it is clear that it is in no way limited thereto and that it comprises all the technical equivalents of the means described and the combinations thereof, where these enter the scope of the invention.

The use of the verb “have”, “comprise” or “include” and the conjugated forms thereof does not exclude the presence of other elements or other steps than those set out in a claim.

In the claims, any reference sign between parentheses should not be interpreted as limiting the claim.

1. A lifting machine (1) comprising:
a main body (2),
a manipulator arm (3) that is mounted on said main body (2) and is movable with respect to the main body (2),
a hydraulic actuator (10, 12, 18) that is configured to move the manipulator arm,
a hydraulic supply device (6) that is connected to the hydraulic actuator (10); and
a control system comprising:
a control unit (7) that is configured to receive a movement request signal from a human-machine interface and to command the hydraulic supply device in response to the movement request signal so as to cause the manipulator arm to move on the basis of the movement request signal,
a position sensor (13, 14, 15) that is configured to transmit a position signal (23) representative of a position of the hydraulic actuator (10, 12, 18) to the control unit (7), the control unit (7) also being configured to detect an end-of-travel stop position of the hydraulic actuator on the basis of the position signal and to command (21) the hydraulic supply device so as to stop the supply of pressure to the hydraulic actuator in response to the detection of the end-of-travel stop position.

2. The lifting machine as claimed in claim 1, wherein the control unit commands (21) the stopping of the supply of pressure to the hydraulic actuator after a delay time has elapsed starting from the detection of the end-of-travel stop position, the delay time being less than or equal to 5 seconds.

3. The lifting machine as claimed in claim 2, wherein the delay time is between 0.5 second and 5 seconds.

4. The lifting machine as claimed in one of claims 1 to 3, wherein the position sensor comprises a linear position sensor.

5. The lifting machine as claimed in one of claims 1 to 4, wherein the position sensor comprises an angular position sensor.

6. The lifting machine as claimed in one of claims 1 to 5, wherein the position sensor is an end-of-travel sensor that is configured to detect an end-of-travel stop position of the hydraulic actuator and to transmit a position signal representative of the end-of-travel stop position of the hydraulic actuator to the control unit (7).

7. The lifting machine as claimed in one of claims 1 to 5, wherein the position signal is a quantitative signal and the control unit (7) is configured to detect the end-of-travel stop position of the hydraulic actuator on the basis of the position signal by comparing a quantity represented by the position signal with a reference value stored in a memory.

8. The lifting machine as claimed in one of claims 1 to 5, wherein the hydraulic actuator (10, 12, 18) is a cylinder comprising a cylindrical part (43) defining an internal chamber (46) and a piston (40) sliding in said internal chamber, and wherein the end-of-travel stop position of the hydraulic actuator corresponds to contact between a first stop piece secured to the cylinder and a second stop piece secured to the piston.

9. The lifting machine as claimed in claim 8, wherein the first and second stop pieces (40, 41, 45) are situated inside the internal chamber (46).

10. The lifting machine as claimed in claim 8, wherein the first and second stop pieces (47, 48) are situated outside the internal chamber (46).

11. The lifting machine as claimed in one of claims 1 to 10, wherein the lift arm (3) has a first end mounted on said main body (2) and a second end opposite to the first end, wherein the hydraulic actuator (18) is a tilt cylinder that is disposed at the second end of the lift arm and intended to tilt a tool with respect to the lift arm (3).

12. The lifting machine as claimed in one of claims 1 to 11, wherein the hydraulic supply device (6) comprises at least one pump driven by a motor (4), and at least one hydraulic distributor.

13. The lifting machine as claimed in one of claims 1 to 12, wherein the human-machine interface comprises a manipulator (9) that is intended to be manipulated by an operator in order to produce the movement request signal.

14. The lifting machine as claimed in one of claims 1 to 13, comprising a state selector that is configured to selectively activate and deactivate in a reversible manner the response of the control unit (7) to the detection of the end-of-travel stop position.

15. The lifting machine as claimed in one of claims 1 to 14, wherein the lifting machine is chosen from:
a telescopic arm lift truck;
a loader;
an aerial personnel lift;
a warehousing machine;
a mast lift truck.
